(19) United States
(12) Patent Application Publication
(10) Pub. No.: US 2004/0121034 A1
(43) Pub. Date: Jun. 24, 2004

(54) Integral injection molding and in-mold coating apparatus

(76) Inventor: Douglas S. McBain, Wadsworth, OH (US)

Correspondence Address: David G. Burleson, Esq., OMNOVA Solutions, Inc., 175 Ghent Road, Fairlawn, OH, 44333-3300, US

(21) Appl. No.: 10/732,881

(22) Filed: Dec. 10, 2003

Related U.S. Application Data
(60) Provisional application No. 60/432,339, filed on Dec. 10, 2002.

(51) Int. Cl. B29C 45/13

(52) U.S. Cl. 425/96; 425/127; 425/130

(57) ABSTRACT

An integral injection molding and in-mold coating arrangement apparatus including a frame, a first mold member fixedly secured to the frame and a second mold member movably secured to the frame for selective movement relative to the first mold member. The second mold member is movable to a closed position adjacent the first mold member for forming a mold cavity. A first composition injector is secured to the frame for selectively injecting a first substrate composition into the mold cavity to form a molded article therein. A second composition injector is secured to one of the first mold member and the second mold member for selectively injecting a second coating composition into the mold cavity and onto the molded article to in-mold coat the molded article. Controls are disposed on the frame for adjustably controlling injection parameters for injecting said first composition and injection parameters for injecting said second composition.

This application claims priority of Provisional Patent Application Serial No. 60/432,339, filed Dec. 10, 2002, entitled “Integral Injection Molding and In-Mold Coating Apparatus.”

### BACKGROUND OF THE INVENTION

1. Field of the Invention

The present invention relates to an integral injection molding and in-mold coating arrangement for molding and in-mold coating a thermoplastic article or substrate. In a first preferred embodiment, the present invention finds particular application as a single machine or apparatus that is capable of injection molding a thermoplastic article and in-mold coating the injection molded thermoplastic article. The single apparatus includes controls for adjustably controlling both the injection molding process and the in-mold coating process. In a second preferred embodiment, the present invention finds particular application as an integral injection molding and in-mold coating arrangement wherein an intelligent injection molding machine is combined with a basic in-mold coating apparatus. The intelligent injection molding machine includes controls for controlling both the injection molding process and the in-mold coating process. In a third preferred embodiment, the present invention finds particular application as an integral injection molding and in-mold coating arrangement wherein a basic injection molding machine is combined with an intelligent in-mold coating apparatus. The intelligent in-mold coating apparatus includes controls for controlling both the injection molding process and the in-mold coating process. The present invention will be described with particular reference to the three preferred embodiments identified above. It is to be appreciated, however, that the invention may relate to other similar environments and applications.

2. Description of the Prior Art

Molded thermoplastic and thermoset articles, such as those made from polyolefins, polycarbonates, polyesters, polyethylenes, polypropylenes, polystyrenes and polyurethanes, are utilized in numerous applications including those for the automotive, marine, recreation, construction, office products, and outdoor equipment industries. Oftentimes, it is desirable to apply a surface coating to a molded thermoplastic or thermoset article. For example, the molded articles may be used as one part in multi-part assemblies. To “match” the finish of the other parts in such assemblies, the molded articles may require application of a surface coating that has the same finish properties as the other parts. Coatings may also be used to improve surface properties of the molded article such as uniformity of appearance, gloss, scratch resistance, chemical resistance, weatherability, and the like. In addition, surface coatings may be used to facilitate adhesion between the molded article and a separate finish coat to be later applied to the molded article.

Numerous techniques have been developed to apply surface coatings to molded plastic articles. Many of these techniques involve the application of a surface coating to plastic articles after they are removed from their molds. These techniques are often multi-step processes involving surface preparation followed by spray-coating the prepared surface with paint or other finishes. In contrast, in-mold coating provides a means of applying a surface coating to molded plastics prior to ejection from the mold. In-mold coating can eliminate the separate manufacturing process of applying a coating to the article upon ejection from the mold thereby reducing the overall cost of manufacturing the article.

Historically, much of the work with in-mold coatings has been done on molded articles made from thermosets. Thermosets, e.g., phenolics epoxies, cross-linked polyesters, and the like, are a class of plastic composite materials that are chemically reactive in their fluid state and are set or cured by a reaction that causes cross-linking of the polymer chains. Once cured, subsequent heating may soften, but will not restore thermosets to a fluid state.

More recently, there has been an interest in in-mold coating articles made from thermoplastics. Thermoplastics are a class of plastic materials that can be melted, cooled to a solid form, and repeatedly re-melted and solidified. The physical and chemical properties of many of the thermoplastic materials, together with their ease of moldability, make them materials of choice in numerous applications in the automotive, marine, recreation, construction, office products, outdoor equipment and other fields.

Because of the inherent differences between the materials, the mold designs and molding techniques used with thermosets are different than those used with thermoplastics. Molds for use with thermosets are typically designed as mated halves with shear edges. One half is typically stationary and the other half typically telescopes vertically over the stationary half. To create a molded article, an uncured thermoset is usually placed on the stationary half with the telescoping half moved apart from the stationary half. After the uncured thermoset is introduced to the mold, heat is applied to both of the mold halves and pressure is applied to the telescoping half of the mold thereby closing the mold halves and forcing and holding the uncured thermoset against the mold surface. Thus, the thermoset article is forced into shape by the movable mold half bearing down on the thermoset material. Subsequently, the formed thermoset article is allowed to cure and can then be removed or ejected from the mold.

Unlike the design of the molds typically used with thermosets, the molds used with thermoplastics usually are of a “clam shell”-like design having mated halves that meet at a parting line. One of the mated halves typically remains stationary whereas the other half of the mold is typically movable between a closed position and an open, retracted position. To form a molded article, the movable half is moved to its closed position and held closed under a clamping force thereby forming a contained molding cavity. Molten thermoplastic material is injected into the molding cavity. The molded article is formed by thoroughly filling the cavity with the thermoplastic composition and allowing the composition to sufficiently cool and solidify. During the entire molding process, the movable mold half is maintained in its closed position. After molding, the mold halves can be opened and a finished, molded article can be ejected therefrom.

Various methods have been used to apply in-mold coatings to molded thermoset and thermoplastic articles. For example, the coatings can be sprayed onto the surface of an open mold prior to closing. However, spray coating can be time-consuming and, when the coating is applied using a volatile organic carrier, may require the use of containment systems. Other in-mold coating processes involve lining the mold with a preformed film of coating prior to molding. The drawback of this in-mold coating process is that, on a commercial scale, this technique can be cumbersome and costly.

Processes have also been developed wherein a fluid coating is injected onto and dispersed over the surface of a molded thermoset part and cured. A common method of injecting a fluid in-mold coating onto the surface of a molded thermoset involves curing the article in the mold to the point that it has hardened sufficiently to accept the coating, reducing the pressure against the telescoping mold half to crack open or part the mold, injecting the fluid coating, and re-pressurizing the mold to distribute the coating over the surface of the molded article. The cracking or parting of the mold involves releasing the pressure exerted on the telescoping mold half to sufficiently move it away from the molded article creating a gap between the surface of the part and the telescoping mold half. The gap allows the coating to be injected onto the surface of the part without removing the part from the mold.

Owing to differences in mold design and molding conditions, processes wherein the mold is cracked or parted prior to injection of an in-mold coating are generally not used for the in-mold coating of injection molded thermoplastics. When molding thermoplastics, it is generally necessary to maintain pressure on the movable mold half to keep the cavity closed and prevent resin from escaping along the parting line. Further, it is often necessary to “pack” or maintain pressure on the thermoplastic material during molding. Packing the mold helps to provide a more uniform crystalline or molecular structure in the molded article. Without packing, the physical properties of the molded thermoplastic article tend to be impaired.

In addition to the problem of resin escaping along the parting line, packing constraints can sometimes create other problems when an in-mold coating is to be injected into a mold containing a thermoplastic article. Specifically, some commercially available in-mold coatings are thermoset materials that cure by the application of heat. Were such coatings to be injected after a molded thermoplastic article has been sufficiently packed to allow the mold to be depressurized and parted or cracked, the molded thermoplastic may lack sufficient heat to cure the coating. Thus, for these types of coatings to cure on a thermoplastic article, they are desirably injected prior to depressurizing the mold.

Because injection molding of thermoplastics does not permit the mold to be parted or cracked prior to injection of the in-mold coating into the mold cavity, the in-mold coating must be injected under sufficient pressure to compress the thermoplastic article in all areas that are to be coated. The compressibility of the molded thermoplastic article dictates how and where the in-mold coating will cover the molded article. The process of in-mold coating an injection molded thermoplastic article with a liquid in-mold coating is described in commonly owned, copending U.S. patent application Ser. Nos. 09/614,953 entitled “Method For In-Mold Coating a Polyolefin Article” filed on Jul. 12, 2000; Ser. No. 09/974,644 entitled “Optimization of In-Mold Coating Injection Molded Thermoplastic Substrate” filed on Oct. 9, 2001; and Ser. No. 10/045,481 entitled “Selectively Controlling In-Mold Coating Flow” filed on Oct. 22, 2001, all expressly incorporated herein by reference.

The method and apparatus used to physically inject the liquid in-mold coating composition into the molding cavity of an injection molding machine during the molding process of a thermoplastic article, also referred to herein as a dispense and control method and apparatus, is described in commonly owned, copending U.S. patent application Ser. No. 60/422,784 entitled “Dispense and Control Apparatus And Method For In-Mold Coating An Injection Molded Thermoplastic Article” filed on Oct. 31, 2002, expressly incorporated herein by reference. The dispense and control apparatus provides a delivery system and method for injecting an in-mold coating into the cavity of a pair of mold halves on an injection molding machine and a means for controlling the delivery system.

As described in the above-referenced patent application, the dispense and control apparatus may take the form of a mobile cart that is generally separate from a conventional injection molding machine but is fluidly connected to the injection molding machine by fluid lines or conduits. The dispense and control apparatus includes its own controls for controlling various parameters related to the in-mold coating process as well as a display means for displaying various information related to the in-mold coating process. The dispense and control apparatus is individually connected to a power source, a compressed air source and the injection molding machine.

Typically, the injection molding machine will include its own controls and display means separate from those of the dispense and control apparatus. The controls on the injection molding machine will control various parameters related to the injection molding process and its display means will display various information related to the injection molding process. The injection molding machine is typically individually connected to a power source and a compressed air source.

To injection mold a thermoplastic part and in-mold coat the molded part, a user or machine operator will have to set and adjust controls on each of two components, the dispense and control apparatus and the injection molding machine. Further, the operator will have to monitor information displayed on each of the two components simultaneously for purposes of controlling the molding and coating processes. For the operator, setting and adjusting controls on two separate components and monitoring information displayed on the two separate components can be cumbersome and inefficient. It would be more desirable for an operator to set and adjust only a single set of controls on a single component that controls both the related processes of molding an article and in-mold coating the molded article. It would be further desirable for the operator to only have to monitor a single display means on a single component that is capable of displaying information related to both processes.

Another potentially undesirable attribute of the separate dispense and control apparatus and conventional injection molding machine arrangement is that each of the components may be required to be individually connected to a power source and/or a compressed air source. It may be more desirable to have a single machine that is capable of both injection molding and in-mold coating. The single machine could be designed to only require a single connection to a power source and a single connection to a compressed air source. The single machine could also eliminate redundant components and functions of the dispense and control apparatus and the injection molding machine. Additionally, a single machine could be designed to be less voluminous or require less floor space than the separate two-component arrangement described in the above-referenced in-mold coating dispense and control apparatus patent application.

Thus, there is a need for an integral in-mold coating and injection molding arrangement wherein the controls for controlling both the injection molding process and the in-mold coating process are located in a single location on a single machine. There is also a need for an integral in-mold coating and injection molding machine, i.e., a single machine on a single frame, that is capable of performing both in-mold coating and injection molding.

### BRIEF SUMMARY OF THE INVENTION

The present invention provides an integral injection molding and in-mold coating arrangement for injection molding a thermoplastic article and in-mold coating the molded article that overcomes the foregoing difficulties and others and provides the aforementioned and other advantageous features.

In accordance with one aspect of the present invention, an integral injection molding and in-mold coating apparatus is provided. More particularly, in accordance with this aspect of the invention, the integral injection molding and in-mold coating apparatus includes a frame, a first mold member fixedly secured to the frame and a second mold member movably secured to the frame for selective movement relative to the first mold member. The second mold member is movable to a closed position adjacent the first mold member for forming a mold cavity. A first composition injector is secured to the frame for selectively injecting a first substrate composition into the mold cavity to form a molded article therein. A second composition injector is secured to one of the first mold member and the second mold member for selectively injecting a second coating composition into the mold cavity and onto the molded article to in-mold coat the molded article. Controls are disposed on the frame for adjustably controlling injection parameters for injecting said first composition and injection parameters for injecting said second composition.

In accordance with another aspect of the present invention, an integral injection molding and in-mold coating apparatus is provided. More particularly, in accordance with this aspect of the invention, the apparatus includes a first mold member and a second mold member forming a contained molding cavity therebetween. A first composition injector is connected to one of the first and second mold members and is fluidly connected to the contained molding cavity for injecting a first composition into the contained molding cavity to form a mold of article therein. A second composition injector is connected to one of the first and second mold members and is fluidly connected to the contained molding cavity for injecting a second composition into the contained molding cavity and onto the molded article to in-mold the coat the molded article. A dispensing apparatus is ridgely connected to the first and second composition injectors. The dispensing apparatus has a metering cylinder fluidly connected to the second composition injector.

In accordance with yet another aspect of the present invention, an injection molding machine and in-mold coating apparatus is provided. More particularly, in accordance with this aspect of the invention, the injection molding machine and in-mold coating apparatus includes an injection molding machine including first and second mold members that form a molding cavity therebetween and a first composition injector for selectively injecting a first composition into the molding cavity to form a mold of article therein. A second composition injector is connected to one of the first and second mold members for selectively injecting a second composition into the molding cavity and onto the molded article to in-mold coat the molded article. A dispense apparatus is separate from the injection molding machine and connected to the second composition injector by a fluid line. A set of controls is on one of the injection molding machine and the dispense apparatus that adjustably controls parameters of the first composition injector, the second composition injector and the dispense apparatus.

### BRIEF DESCRIPTION OF THE DRAWINGS

The invention may take physical form in various components and arrangements of components, and in various steps and arrangements of steps. The drawings are only for purposes of illustrating preferred embodiments and are not to be construed as limiting the invention.

FIG. 1 is a side view of one embodiment of a molding apparatus suitable for use in or with preferred embodiments of the present invention.

FIG. 2 is a partial cross-section through a vertical elevation of a mold cavity.

FIG. 3 is a perspective view of an in-mold coating dispense and control apparatus having a display means and adapted to be connected to the molding apparatus of FIG. 1.

FIG. 4 is a side view of an integral injection molding and in-mold coating apparatus according to one preferred embodiment of the present invention.

### DETAILED DESCRIPTION OF THE INVENTION

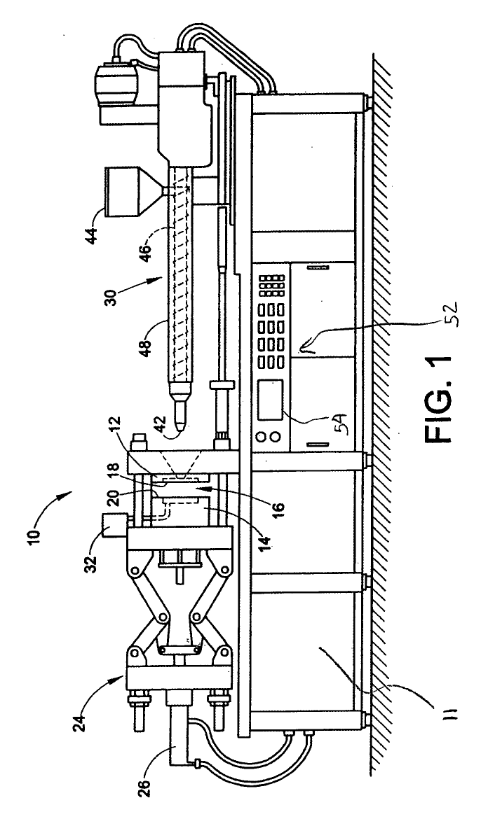

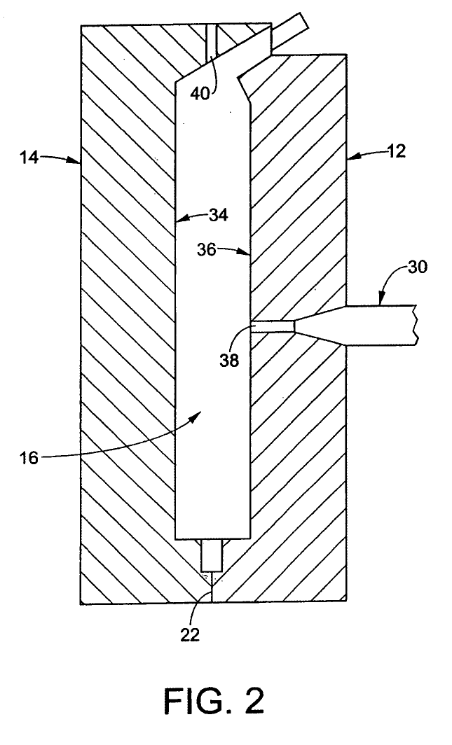

Referring now to the drawings wherein the showings are for purposes of illustrating preferred embodiments of the invention only and not for purposes of limiting the same and like reference numerals are used to indicate like or corresponding parts throughout the Figures, FIG. 1 shows a molding apparatus or injection molding machine 10 including a first mold member or half 12 and a second mold member or half 14. More particularly, the molding apparatus 10 includes a frame 11 that supports the first and second mold halves 12,14. The first mold half 12 is fixedly secured or connected to the frame 11 and the second mold half 14 is movably secured or connected to the frame 11 for selective movement relative to the first mold half 12. Thus, the first mold half 12 preferably remains in a stationary or fixed position relative to the second movable mold half 14. In FIG. 1, the movable mold half 14 is shown in an open position. The movable mold half 14 is movable to a closed position adjacent the first mold half 12 wherein the first and second mold halves mate with one another to form a contained mold or molding cavity 16 therebetween (FIG. 2). More specifically, the mold halves 12,14 mate along surfaces 18 and 20 (FIG. 1) when the movable mold half 14 is in its closed position forming a parting line 22 (FIG. 2) therebetween and around the cavity 16.

The movable mold half 14 reciprocates generally along a horizontal axis relative to the first or fixed mold half 12 by action of a clamping mechanism 24 with a clamp actuator 26 such as through a hydraulic, pneumatic or mechanical actuator as known in the art. The clamping pressure exerted by the clamping mechanism 24 should have an operating pressure in excess of the pressures generated or exerted by either one of a first composition injector 30 and a second composition injector 32. In the preferred embodiment, the pressure exerted by the clamping mechanism 24 ranges generally from about 2,000 pounds per square inch (psi) or 138 bar to about 15,000 psi or 1033 bar, preferably from about 4,000 psi or 276 bar to about 12,000 psi or 827 bar, and more preferably from about 6,000 psi or 413 bar to about 10,000 psi or 689 bar of the mold surface. Thus, the clamping mechanism 24 selectively maintains the second mold half 14 in the closed position and in fixed relation relative to the first mold half 12 by application of a clamping pressure.

With additional reference to FIG. 2, the mold half 14 is shown in a closed position abutting or mating with the mold half 12 along the parting line 22 to form the mold cavity 16. It should be readily understood by those skilled in the art that the design of the cavity 16 can vary greatly in size and shape according to the desired end product or article to be molded. The mold cavity 16 generally has a first surface 34 on the second mold half 14 and a corresponding or opposite second surface 36 on the first mold half 12. The first mold half 12 defines a first orifice 38 connecting to the cavity 16 that allows the first composition injector 30 to inject its composition into the cavity 16. Similarly, the second mold half 14 defines a second orifice 40, also connected to the cavity 16, that allows the second composition injector 32 (FIG. 1) to inject its composition into the cavity 16.

The first composition injector 30 is secured to the frame 11 for selectively injecting a first composition into the mold cavity 16 to form a molded article therein. The injector 30 can be that of a typical injection molding apparatus which is well known to those of ordinary skill in the art. More specifically, the first composition injector 30 is generally capable of injecting the first composition, which can be a thermoplastic composition, generally a resin or polymer, into the mold cavity 16. Owing to space constraints, the first injector 30 used to inject the thermoplastic composition is positioned to inject material from the fixed half 12 of the mold. It is to be understood that the first composition injector 30 could be reversed and placed in the movable mold half 14. The second composition injector 32 is generally capable of selectively injecting a second or in-mold coating composition into the mold cavity 16 and onto the molded article to coat the molded article formed therein. In the illustrated embodiment, the second injector 32 is shown positioned in or secured to the movable mold half 14. However, it is to be understood that the second injector 32 could be alternatively positioned in or secured to the stationary mold half 12.

The first composition injector 30 is shown in a “backed off” position, but it is readily understood that the same can be moved in a horizontal direction so that a nozzle or resin outlet 42 of the first injector 30 mates with the mold half 12. In the mated position, the injector 30 is capable of injecting its contents into the mold cavity 16. For purposes of illustration only, the first composition injector 30 is shown as a reciprocating-screw machine wherein a first composition can be placed in a hopper 44 and a rotating screw 46 can then move the composition through a heated extruder barrel 48, where the first composition or material is heated above its melting point. As the heated material collects near the end of the barrel 48, the screw 46 acts as an injection ram and forces the material through the nozzle 42 and into the mold cavity 16. The nozzle 42 optionally has a valve (not shown) at the open end thereof and the screw 46 generally has a non-return valve (not shown) to prevent the backflow of material into the screw 46.

The injection molding machine 10 further includes a set of controls 52 disposed on the frame 11 for adjustably controlling the injection molding process. The controls 52 of the injection molding machine 10 enable an operator to adjust and/or set certain operating parameters (also referred to herein as injection parameters) of the injection molding machine 10 including, specifically, those parameters related to the injection molding process. For example, the controls can be manipulated to increase or decrease the amount of the thermoplastic material that is forced into the mold cavity, the pressure at which the thermoplastic material is forced into the mold cavity, the duration of time that the thermoplastic material is forced into the mold cavity under a specific pressure or range of pressures, etc. The injection molding machine 10 further includes a display means such as a monitor 54. The monitor 54 can display, optionally in real time, any data or information being sensed and/or recorded by the injection molding machine.

The first composition injector 30 is not meant to be limited to the embodiment shown in FIG. 1 but can be any apparatus capable of injecting a thermoplastic composition into the mold cavity 16. For example, the injection molding machine can have a mold half movable in a vertical direction or may be a “stack-mold” with center injection. Other suitable injection molding machines include many of those available from Cincinnati-Milacron, Inc. of Cincinnati, Ohio; Battenfeld Injection Molding Technology of Meinlerzhagen, Germany; Engel Machinery Inc. of York, Pa.; Husky Injection Molding Systems Ltd. of Bolton, Canada; BOY Machines Inc. of Exton, Pa. and others.

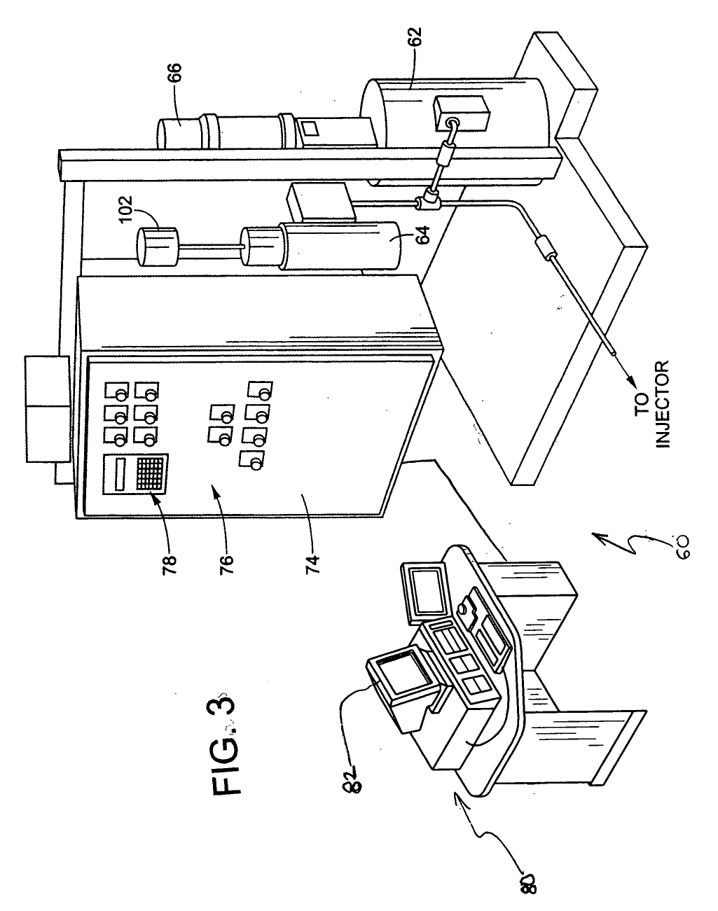

With reference to FIG. 3, an in-mold coating dispense and control apparatus 60 is capable of being connected to the molding apparatus 10 for providing in-mold coating capabilities and controls therefor to the molding apparatus 10. The control apparatus 60 is generally described in the above-referenced commonly owned, copending U.S. patent application Ser. No. 60/422,784 entitled “Dispense and Control Apparatus and Method for In-Mold Coating an Injection Molded Thermoplastic Article” filed on Oct. 31, 2002, which is expressly incorporated herein by reference.

As described in the '784 application, the control apparatus 60 includes an in-mold coating container receiving cylinder 62 for holding an in-mold coating container with an in-mold coating composition therein. A suitable in-mold coating composition is disclosed in commonly owned, U.S. Pat. No. 5,777,053 entitled “In-Mold Coating Compositions Suitable As Is For An End Use Application” issued on Jul. 7, 1998, expressly incorporated herein by reference. The control apparatus 60 further includes a metering cylinder or tube 64 that is adapted to be in fluid communication with the in-mold coating container when received in the receiving cylinder 62. An air-driven transfer pump 66 is provided on the control apparatus 60 and is capable of pumping the in-mold coating composition from the receiving container 62 to the metering cylinder 64 as will be described in more detail below.

The metering cylinder 64 is selectively fluidly connectable to the second injector 32 on the molding apparatus 10. The metering cylinder 64 includes a hydraulic means such as a hydraulic piston for evacuating in-mold coating from the metering cylinder 64 and directing the evacuated in-molding coating to the second injector 32. A return line (not shown) is connected to the second injector 32 and to the receiving container 62 to fluidly communicate therebetween. The control apparatus 60 further includes an electrical box 74 capable of being connected to a conventional power source by an electrical connector (not shown). The electrical box 74 includes a plurality of controls 76 including a touch pad controller 78 thereon for controlling the dispensing of in-mold coating to the mold cavity 16 of the molding apparatus 10.

The controls 76 of the control apparatus 60 enable the operator to adjust and/or set certain operating parameters of the apparatus 60 including those parameters (also referred to herein as injection parameters) related to the in-mold coating process. For example, the controls can be manipulated to increase or decrease the amount of an in-mold coating composition to be injected into the mold cavity 16. Additionally, the controls 76 and/or keypad 78 can be manipulated to adjust when in the molding process that the in-mold coating composition is injected into the mold cavity 16.

The dispense and control apparatus 60 further includes an image processor 80 connected to the electrical box 74 and having a display means such as a monitor 82 for displaying data related to the dispense and control apparatus 60. More particularly, the display means can display, optionally in real time, any data or information being sensed and/or recorded by the apparatus 60. Optionally, the dispense apparatus 60 includes a user interface that allows a user to simply select a part icon on the display means that represents a series of parts to be molded and coated. Selection of a specific part icon on the user interface presets the control parameters on the dispense apparatus 60. The user interface eliminates the need for an operator to set the control parameters individually each time a new part series is to be run through the molding and coating process. The user interface can be a touch screen user interface wherein the display means allows a user to make selections by touching or pressing appropriate locations on the display means or a screen of the display means.

A compressed air connector (not shown) is provided on the control apparatus 60 for connecting the apparatus 60 to a conventional compressed air line. Compressed air is used to drive the transfer pump 66 and remove in-mold coating from the control apparatus 60 and its fluid communication lines during a “cleanout” operation. Additionally, air can be used to move a solvent through the communication lines for cleaning purposes.

The dispense and control apparatus 60 further includes a remote sensor (not shown) that is adapted to be positioned, in the preferred embodiment, on one of the mold halves 12,14. The sensor can be a conventional rocker switch that sends a signal to the apparatus 60 upon actuation. The sensor is positioned on one of the mold halves 12,14 such that it is actuated upon closure of the mold halves 12,14. The signal sent from the sensor is used to initiate a timer on the control apparatus 60. Alternatively, the sensor could be placed in another location such as the tie bar-machine ways to indicate when the mold halves 12,14 are closed.

Alternatively, the molding apparatus 10 may be equipped with a sensor or sensor means that has the ability to generate a signal upon closure of the mold halves 12,14. A conventional signal transfer cable could be connected between the molding apparatus 10 and the control apparatus 60 for communicating the signal to the control apparatus 60. Such an arrangement would eliminate the need for an independent sensor to be connected to one of the mold halves 12,14.

To prepare for injection of the in-mold coating composition into the mold cavity, an in-mold coating container of a desired in-mold coating composition is placed in the receiving cylinder 62. The metering cylinder 64 is fluidly connected to the container and the second injector 32. The return line 68 is fluidly connected to the second injector 32 and the receiving cylinder 62. The electrical connector of the control apparatus 60 is connected to a suitable power source such as a conventional 460 volt AC or DC electrical outlet to provide power to the electrical box 74. The compressed air connector of the control apparatus 60 is also connected to a compressed air source to provide a pneumatic means, such as a compressed air source, for evacuating in-mold coating from the apparatus 60 and its fluid communication lines when a “cleanout” operation is desirable and/or moving a solvent through the apparatus 60 and its fluid communication lines. The remote sensor is appropriately positioned on one of the mold halves 12,14 as described above.

To make an in-mold coated thermoplastic article, with reference to FIG. 1, a thermoplastic first composition is placed in the hopper 44 of the molding apparatus 10. The first injector 30 is moved into nesting or mating relation with the fixed mold half 12. Through conventional means, i.e., using the heated extruder barrel 48 and the rotating screw 46, the first injector 30 heats the first composition above its melting point and directs the heated first composition toward the nozzle 42 of the first injector 30. The mold halves 12,14 are closed thereby creating the contained molding cavity 16 having a substantially fixed volume. As described above, the sensor of the control apparatus 60 is positioned on one of the mold halves 12,14 such that when the mold halves 12,14 are closed together the sensor sends a signal to the control apparatus 60 indicating that the mold halves 12,14 are closed and that the molding process has begun.

Upon receipt of the signal, hereinafter referred to as Tₒ, the dispense and control apparatus 60 initiates the timer contained therein. The timer is used to track elapsed time from Tₒ. At predetermined elapsed time intervals, the apparatus 60 actuates and controls various in-mold coating related functions to insure that the in-mold coating is delivered to the cavity 16 at a desired point in the molding process. Thus, the apparatus 60 operates simultaneously with the molding apparatus 10.

After Tₒ, the molding process continues and a nozzle valve (not shown) of the nozzle 42 is moved to an open position for a predetermined amount of time to allow a corresponding quantity of the first composition to enter the mold cavity 16. The screw 46 provides a force or pressure that urges or injects the first composition into the mold cavity 16 until the nozzle pin is returned to its closed position. The first composition is filled and packed into the mold cavity 16 as is well known in the art. Once the mold cavity 16 is filled and packed, the molded first composition is allowed to cool thereby forming a molded thermoplastic article.

After the first composition has been injected into the mold cavity and the surface of the molded article to be coated has cooled below the melt point or otherwise reached a temperature or modulus sufficient to accept or support an in-mold coating but before the surface has cooled too much such that curing of the in-mold coating would be inhibited, a predetermined amount of a second composition which is an in-mold coating composition is ready to be introduced into the mold cavity through the second orifice 40 (FIG. 2) of the second composition or in-mold coating injector 32. This point in the molding process, hereinafter referred to as T_{IMC}, can be characterized as an elapsed time from Tₒ. In order for the second injector 32 to inject the in-mold coating precisely at T_{IMC}, the apparatus 60 has to perform several functions at precise times between Tₒ and T_{IMC}. Each of these functions occurs at a predetermined elapsed time relative to Tₒ.

One such function is filling the metering cylinder 64 with a desired amount of in-mold coating. This function occurs a predetermined elapsed time from Tₒ but in advance of T_{IMC}. Thus, at the preselected elapsed time, the control apparatus 60 opens a valve (not shown) that permits fluid communication between the in-mold coating-filled container and the metering cylinder 64. The transfer pump 66 then pumps in-mold coating from the container to the metering cylinder 64. When the metering cylinder 64 is filled a desired amount, the valve closes to prevent more in-mold coating from entering the cylinder. The amount of in-mold coating permitted to enter the cylinder 64 is selectively adjustable as will be described in more detail below.

After the metering cylinder 64 is filled and just prior to T_{IMC}, the control apparatus 60 opens a pin or valve (not shown) on the second injector 32 to allow fluid communication between the second injector 32 and the mold cavity 16. The pin is normally bias or urged toward a closed position, i.e., flush to the mold surface, but is selectively movable toward the open position by the control apparatus 60. Specifically, in the preferred embodiment, an electrically powered hydraulic pump (not shown) of the control apparatus 60 is used to move the pin. Immediately or very shortly thereafter, at T_{IMC}, the hydraulic means of the metering cylinder 64 evacuates the in-mold coating contained therein and delivers the in-mold coating to the second injector 32 where it passes through the orifice 40 and into the mold cavity 16.

It is important to note that the mold is not opened or unclamped before the in-mold coating is applied. That is, the mold halves maintain a parting line and generally remain a substantially fixed distance relative to one another while both the first and second compositions are injected into the mold cavity. Thus, the substantially fixed volume of the mold cavity 16 is constant and maintained through the molding and coating steps. When injected, the in-mold coating composition spreads out from the mold surface and coats a predetermined portion or area of the molded article. Immediately or very shortly after the in-mold coating composition is fully injected into the mold cavity 16, the apparatus 60 allows the valve of the second injector 32 to return to its closed position thereby preventing further injection of the in-mold coating into the mold cavity 16.

After the predetermined amount of in-mold coating is injected into the mold cavity 16 and it covers or coats the predetermined area of the article or substrate, the coated substrate can be removed from the mold. However, before the mold halves are parted, the in-mold coating is cured by components present within the coating composition. The cure is optionally heat activated, from sources including the substrate or mold halves which are at or above the curing temperature of the in-mold coating. Cure temperature will vary depending on the in-mold coating utilized. As mentioned above, it is important to inject the in-mold coating before the molded article has cooled to the point below where proper curing of the coating can be achieved. The in-mold coating requires a minimum temperature to activate the catalyst present therein which causes a cross-linking reaction to occur, thereby curing and bonding the coating to the substrate.

Between in-mold coating injections, the control apparatus 60 optionally uses the transfer pump 66 to circulate the in-mold coating composition through the system. The pin on the second injector 32 remains in its closed position thereby preventing an in-mold coating composition from entering the mold cavity 16. One purpose of circulating the in-mold coating between cycles is to prevent any particular portion of the coating from becoming undesirably heated due to its proximity to heating mechanisms on the molding apparatus 10. Such heating could detrimentally impact the material properties of the in-mold coating or could “lock-up” the in-mold coating fluid lines by solidifying the in-mold coating composition therein.

As discussed above, the controls 76 of the control apparatus 60 enable an operator to adjust and/or set certain operating parameters of the apparatus 60. To control the amount of in-mold coating composition to be injected into the mold cavity the controls 76 are manipulated such that a desired amount of the in-mold coating composition is allowed to enter the metering cylinder 64 by allowing the valve that controls communication between the cylinder 64 and the receiving container 62 to remain open for a longer duration. Additionally, the controls 76 can be manipulated to adjust the elapsed time from Tₒ that the metering cylinder 64 is filled by the transfer pump 66 and/or the amount of time elapsed from Tₒ that the cylinder 64 is emptied by the hydraulic means. This time may be adjusted to more closely approximate T_{IMC}. Several alternate embodiments are discussed and described in the '784 application and all should be considered within the scope of the present invention.

As described, the injection molding machine 10,60 is spaced apart or separate from the dispense and control apparatus 60 and the machine and apparatus 10,60 each include their own respective controls as well as their own respective display means or monitors. The controls 52 on the injection molding machine 10 only control parameters generally related to the injection molding process and its monitor 54 only displays information generally related to the injection molding process. Similarly, the controls 76 of the dispense and control apparatus 60 only control or set parameters generally related to the in-mold coating process and its monitor 82 only displays information generally related to the in-mold coating process. As already discussed, the problem with this arrangement is that the operator has to set and adjust the controls 52 and the controls 76 which are located on two separate components 10,60. Further, the operator has to monitor both of the monitors 54,82 of the two separate components 10,60 simultaneously.

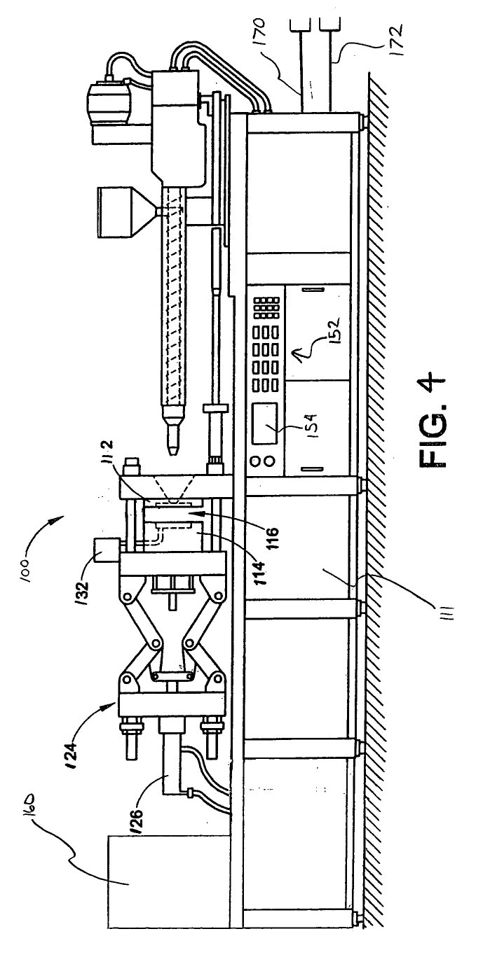

With reference to FIG. 4, in accordance with a first preferred embodiment, an integral injection molding and in-mold coating apparatus 100 is adapted to injection mold a thermoplastic article and in-mold coat the injection molded article. The apparatus 100 includes all of the functionality of the injection molding machine 10 described above and all of the functionality of the dispense and control apparatus 60 described above. Specifically, the apparatus 100 includes a frame 111, a first mold member 112 fixedly secured to the frame 111 and a second mold member 114 movably secured to the frame 111 for selective movement relative to the first mold member. Like the mold member 14, the mold member 114 is movable to a closed position adjacent the first mold member for forming a mold cavity 116.

Like the first composition injector 30, a first composition injector 130 is secured to the frame 111 for selectively injecting a first composition into the mold cavity 116 to form a molded article therein. The mold members 112, 114 and the first composition injector 130 function and operate like the mold members 12,14 and the first composition injector 30. The apparatus 60 also includes a second composition injector 132 like the injector 32. The injector 132 is secured to the second mold member 114 for selectively injecting a second composition into the mold cavity 116 and onto the molded article to in-mold coat the molded article. Like the injector 32, the injector 132 can be alternatively secured to the first mold member 112. A clamping mechanism 124 with a clamp actuator 126 functions like the clamp mechanism 24 with its clamp actuator 126.

The apparatus 100 further includes a dispense apparatus 160 (shown schematically) disposed or rigidly connected to the frame 111 and the first and second composition injectors 130,132 thereby forming a unitary or integral injection molding and in-mold coating apparatus. Aside from being disposed on the frame 111, the dispense apparatus 160 is like the dispense apparatus 60 in most other respects. For example, although not shown, the dispense apparatus 160 includes a receiving cylinder for holding a container of the second composition, a receiving cylinder in fluid communication with the container and the second composition injector 132 (fluidly connecting the dispense apparatus 160 to the second composition injection 132), a pump fluidly connected to the metering cylinder for transferring the second composition from the container to the metering cylinder and a hydraulic means, such as a hydraulic cylinder, for selectively evacuating the second composition from the metering cylinder and directing the second composition to the second composition injector 132.

The apparatus 160 further includes a set of controls 152 disposed on the frame capable of and for adjustably controlling various parameters related to both the injection molding process and the in-mold coating process. Specifically, the controls 152 adjustably set parameters of the first injector 130, the second injector 132 and the dispense apparatus 160 as well as the clamp mechanism 124. The apparatus 160 further includes a display means or monitor 154 capable of displaying information or data related to either or both of the injection molding process and the in-mold coating process.

The controls 152 on the apparatus 160 allow the operator to manipulate one set of controls for controlling two processes: the injection molding process and the in-mold coating process. Further, the monitor 154 on the apparatus 160 allows the operator to view or monitor a single monitor or feedback device that can display information or data about both the injection molding process and the in-mold coating process. Optionally, the controls 152 and the monitor 154 can be partially or fully combined into a user interface such as a touch screen user interface that both displays information related to the two processes, including the first and second injectors 130,132 and the dispense apparatus 160, and allows the operator to adjust the parameters of the two processes by pressing the appropriate location of the touch screen.

In any configuration, the apparatus 160 that is capable of both injection molding and in-mold coating provides additional advantages. For example, the apparatus 160 can include only a single compressed air source connection 170 that only needs to be connected to a single compressed air source. The single connection 170 is connected to and provides compressed air, as needed, to the dispense apparatus 160 and the first and second composition injectors 130,132. The apparatus 160 can also include only a single electrical source connection 172 that only needs to be connected to a single electrical source. The single connection 172 is electrically connected to and provides power to the dispense apparatus 160, the first injector 130 and the second injector 132. As a result, certain redundant parts or components can be eliminated in the single machine that would be required in the separate molding machine 10 and control apparatus 60. Combining the processes into a single machine also permits the single machine to be less voluminous or spacious relative to the separate molding machine 10 and control apparatus 60. In most other respects, the integral apparatus 160 functions like the injection molding machine 10 and the dispensing apparatus 60, including maintaining a fixed volume, contained cavity throughout the injection molding process and the in-mold coating process.

In accordance with a second preferred embodiment, an integral injection molding and in-mold coating arrangement includes an intelligent injection molding machine and a basic in-mold coating apparatus. In most respects, the intelligent injection molding machine is like the molding machine 10 and the basic in-mold coating apparatus is like the dispense apparatus 60. However, the intelligent injection molding machine includes controls for adjustably controlling both the injection molding process and the in-mold coating process. Further, the intelligent injection molding machine includes a display means such as a monitor that is capable of displaying information related to both the injection molding process and the in-mold coating process.

In accordance with a third preferred embodiment, an integral injection molding and in-mold coating arrangement includes a basic injection molding machine and an intelligent in-mold coating apparatus. In most respects, the basic injection molding machine is like the injection molding machine 10 and the intelligent in-mold coating apparatus is like the dispense apparatus 60. However, the intelligent in-mold coating apparatus includes controls for adjustably controlling both the injection molding process and the in-mold coating process. Further, the intelligent dispense apparatus includes a display means such as a monitor that is capable of displaying information related to both the injection molding process and the in-mold coating process.

In any of the preferred embodiments discussed herein, the controls that adjustably control both the injection molding process and the in-mold coating process may be at least partially combined with the display means to provide the operator with a touch-screen user interface. The touch-screen user interface displays a plurality of icons. Each of the plurality of icons represents a specific series of parts to be molded and coated. The operator selects a specific series of parts to be molded and coated. The operator selects a specific icon of the plurality of icons by touching the appropriate icon that corresponds to the specific series of parts to be molded and coated. Selection of the appropriate icon presets one or more of the control parameters related to the molding process and/or the in-mold coating process. This eliminates the need for the operator to manually set each of the control parameters each time a new series of parts is to be injection molded and in-mold coated.

The invention has been described with reference to the preferred embodiments. Obviously, modifications and alterations will occur to others upon reading and understanding the preceding detailed description. It is intended that the invention be construed as including all such modifications and alterations insofar as they are within the scope of the appended claims or the equivalents thereof.

1. An integral injection molding and in-mold coating apparatus, comprising:
a frame;
a first mold member fixedly secured to the frame and a second mold member movably secured to the frame for selective movement relative to the first mold member, the second mold member movable to a closed position adjacent the first mold member for forming a mold cavity;
a first composition injector secured to the frame for selectively injecting a first substrate composition into the mold cavity to form a molded article therein;
a second composition injector secured to one of the first mold member and the second mold member for selectively injecting a second coating composition into the mold cavity and onto the molded article to in-mold coat the molded article; and
controls disposed on the frame for adjustably controlling injection parameters for injecting said first composition and injection parameters for injecting said second composition.

2. The integral injection molding and in-mold coating apparatus of claim 1 further including a dispense apparatus disposed on the frame and fluidly connected to the second composition injector.

3. The integral injection molding and in-mold coating apparatus of claim 2 wherein the dispense apparatus includes:
a receiving cylinder for holding a container of the second composition;
a metering cylinder in fluid communication with the container and the second composition injector;
a pump fluidly connected the metering cylinder for transferring the second composition from the container to the metering cylinder; and
a hydraulic means connected to the metering cylinder for selectively evacuating the second composition from the metering cylinder and directing the second composition to the second composition injector.

4. The integral injection molding and in-mold coating apparatus of claim 2 wherein the set of controls includes a touch screen user interface that controls the first composition injector, the second composition injector and the dispense apparatus.

5. The integral injection molding and in-mold coating apparatus of claim 2 further including only a single compressed air source connection connected to the dispense apparatus, the first composition injector and the second composition injector.

6. The integral injection molding and in-mold coating apparatus of claim 2 further including only a single electrical source connection electrically connected to the dispense apparatus, the first composition injector and the second composition injector.

7. The integral injection molding and in-mold coating apparatus of claim 1 further including a clamp mechanism that selectively maintains the second mold member in the closed position and in fixed relation relative to the first mold member by application of a clamping pressure.

8. The integral injection molding and in-mold coating apparatus of claim 1 wherein the mold cavity defined by the first and second mold members has a fixed volume when the first mold member is in the closed position.

9. The integral injection molding and in-mold coating apparatus of claim 1 wherein the mold cavity defined by the first and second mold members is a contained cavity.

10. The integral injection molding and in-mold coating apparatus of claim 1 further including:
a dispense apparatus disposed on the frame and fluidly connected to the second injector for providing the second composition to the second injector under an injection pressure; and
a display means that displays information related to at least one of the first injector, the second injector and the dispense apparatus.

11. The integral injection molding and in-mold coating apparatus of claim 10 wherein the display means communicates information related to each of the first composition injector, the second composition injector and the dispense apparatus.

12. The integral injection molding and in-mold coating apparatus of claim 11 wherein the display means is a monitor.

13. The integral injection molding and in-mold coating apparatus of claim 2 wherein the injection parameters include at least one of (a) the amount of said second composition injected, (b) when in the molding process said second composition is injected, (c) the pressure at which said second composition is injected, (d) the duration for which said second composition is injected, (e) the amount of said first composition injected, (f) the pressure at which said first composition is injected, and (g) the duration for which said first composition is injected.

14. An integral injection molding and in-mold coating apparatus, comprising:
a first mold member and a second mold member forming a contained molding cavity therebetween;
a first composition injector connected to one of the first and second mold members and fluidly connected to the contained molding cavity for injecting a first composition into the contained molding cavity to form a molded article therein;
a second composition injector connected to one of the first and second mold members and fluidly connected to the contained molding cavity for injecting a second composition into the contained molding cavity and onto the molded article to in-mold coat the molded article; and
a dispensing apparatus rigidly connected to the first and second composition injectors, the dispensing apparatus having a metering cylinder fluidly connected to the second composition injector.

15. The integral injection molding and in-mold coating apparatus of claim 14 further including a single set of controls for adjustably setting parameters of the first composition injector, the second composition injector and the dispense apparatus.

16. The integral injection molding and in-mold coating apparatus of claim 15 further including:
a clamp mechanism for moving the first mold member relative to the second mold member, the contained molding cavity formed when the first mold member is in a closed position.

17. The integral injection molding and in-mold coating apparatus of claim 16 wherein the single set of controls operates the clamp mechanism.

18. The integral injection molding and in-mold coating apparatus of claim 14 including a single display device that shows information related to the first composition injector, the second composition injector and the dispense apparatus.

19. The integral injection molding and in-mold coating apparatus of claim 18 wherein the single display device includes a touch screen interface that allows adjustments to parameters of the first composition injector, the second composition injector and the dispense apparatus to be made by touching the display device in specified locations.

20. The integral injection molding and in-mold coating apparatus of claim 14 wherein the dispense apparatus includes:
a receiving cylinder for holding a container of the second composition that is in fluid communication with the metering cylinder;
a pump fluidly connected the metering cylinder for transferring the second composition from the container to the metering cylinder; and
a hydraulic cylinder connected to the metering cylinder for selectively evacuating the second composition from the metering cylinder and directing the second composition to the second composition injector.

21. An injection molding machine and in-mold coating apparatus, comprising:
an injection molding machine including first and second mold members that form a molding cavity therebetween and a first composition injector for selectively injecting a first composition into the molding cavity to form a molded article therein;
a second composition injector connected to one of the first and second mold members for selectively injecting a second composition into the molding cavity and onto the molded article to in-mold coat the molded article;
a dispense apparatus separate from the injection molding machine and connected to the second composition injector by a fluid line; and
a set of controls on one of the injection molding machine and the dispense apparatus that adjustably controls parameters of the first composition injector, the second composition injector and the dispense apparatus.
